(19) United States
(12) Patent Application Publication
(10) Pub. No.: US 2022/0164417 A1
(43) Pub. Date: May 26, 2022

(54) METHOD OF EVALUATING ROBUSTNESS OF ARTIFICIAL NEURAL NETWORK WATERMARKING AGAINST MODEL STEALING ATTACKS

(71) Applicant: KOREA ADVANCED INSTITUTE OF SCIENCE AND TECHNOLOGY, Daejeon (KR)

(72) Inventors: Sooel Son, Daejeon (KR); Suyoung Lee, Daejeon (KR)

(21) Appl. No.: 17/361,994

(22) Filed: Jun. 29, 2021

(30) Foreign Application Priority Data
Nov. 20, 2020 (KR) 10-2020-0156142

(51) Int. Cl. G06F 21/14; G06F 21/16; G06N 3/08

(52) U.S. Cl. CPC G06F 21/14; G06N 3/08; G06F 21/16

(57) ABSTRACT

Disclosed is a method of evaluating robustness of artificial neural network watermarking against model stealing attacks. The method of evaluating robustness of artificial neural network watermarking may include the steps of: training an artificial neural network model using training data and additional information for watermarking; collecting new training data for training a copy model of a structure the same as that of the trained artificial neural network model; training the copy model of the same structure by inputting the collected new training data into the copy model; and evaluating robustness of watermarking for the trained artificial neural network model through a model stealing attack executed on the trained copy model.

### CROSS-REFERENCE TO RELATED APPLICATION(S)

This application claims the benefit of Korean Patent Application No. 10-2020-0156142 filed on Nov. 20, 2020, in the Korean Intellectual Property Office, the disclosure of which is incorporated herein by reference.

### BACKGROUND OF THE INVENTION

### 1. Field of the Invention

The following description relates to a method of evaluating robustness of a watermarking technique for proving ownership of an artificial neural network from the perspective of a model stealing attack, and evaluation criteria thereof.

### 2. Description of Related Art

As artificial neural networks are used in various fields such as autonomous vehicles, image processing, security, finance and the like, the artificial neural networks may be targeted by many malicious attackers. In order to cope with the attacks, several watermarking techniques have been proposed recently to prove the ownership of an original owner when an artificial neural network is stolen by a malicious attacker (non-patent documents [1] and [2]).

This technique is divided into a watermark learning step and an ownership verification step. First, at the watermark learning step, a pair of a key image and a target label serving as a watermark of an artificial neural network are additionally learned together with normal training data. At this point, the key image and the target label should be designed not to be predicted by third parties so that the watermark may not be easily exposed to attackers.

Thereafter, at the ownership verification step, the original owner of the artificial neural network may prove ownership by querying a model on the learned key image and showing that the model returns the learned target label. It is known that watermarking of an artificial neural network is possible in a way of training key images without lowering the original accuracy of the model owing to over-parameterization of the artificial neural network (non-patent documents [3] and [4]).

Watermarking techniques like this are defense techniques for protecting the original owner of an artificial neural network, and their robustness should be guaranteed against various attacking attempts of erasing watermarks. However, prior studies evaluate robustness of watermarking techniques only against some threats such as pruning attack, fine-tuning attack, evasion attack and the like, and have not verified the robustness against model stealing attacks that can be utilized as an attack for removing watermarks.

The model stealing attack is originally an attack used for copying a model that shows performance similar to that of a target model when an attacker is able to observe input and output of the model (non-patent document [5]). In the process, the attacker constructs a new dataset by giving an arbitrary image to the original model as an input and collecting output values. The newly collected data set may be a sample representing the original model, and accordingly, when a new model is trained using a corresponding data set, an artificial neural network showing performance similarly to that of the original model can be trained. From the perspective of artificial neural network watermarking, the model stealing attack can be used to extract only the original function, excluding the function of memorizing watermarks, from the original model.

### NON-PATENT DOCUMENTS

[1] Jialong Zhang, Zhongshu Gu, Jiyong Jang, Hui Wu, Marc Ph. Stoecklin, Heqing Huang, and Ian Molloy. 2018. Protecting Intellectual Property of Deep Neural Networks with Watermarking. In Proceedings of the ACM Asia Conference on Computer and Communications Security. 159-172.

[2] Yossi Adi, Carsten Baum, Moustapha Cisse, Benny Pinkas, and Joseph Keshet. 2018. Turning Your Weakness Into a Strength: Watermarking Deep Neural Networks by Backdooring. In Proceedings of the USENIX Security Symposium. 1615-1631.

[3] Anna Choromanska, Mikael Henaff, Michael Mathieu, Gerard Ben Arous, and Yann LeCun. 2015. The Loss Surfaces of Multilayer Networks. In Proceedings of the International Conference on Artificial Intelligence and Statistics. 192-204.

[4] Chiyuan Zhang, Samy Bengio, Moritz Hardt, Benjamin Recht, and Oriol Vinyals. 2017. Understanding Deep Learning Requires Rethinking Generalization. In Proceedings of the International Conference on Learning Representations.

[5] Tribhuvanesh Orekondy, Bernt Schiele, and Mario Fritz. 2019. Knockoff Nets: Stealing Functionality of Black-Box Models. In Proceedings of the IEEE Conference on Computer Vision and Pattern Recognition. 4954-4963.

### SUMMARY OF THE INVENTION

In order to evaluate whether a watermarking technique for proving ownership of an artificial neural network is robust against model stealing attacks, the present invention may provide a method and system for executing a simulated attack on a watermarked artificial neural network, and evaluating robustness of the watermarking technique by utilizing various evaluation criteria.

Particularly, the present invention may provide a method and system for newly defining a process of performing a model stealing attack, for which robustness of existing watermarking techniques has not been evaluated, and criteria for evaluating how robust a watermarking technique of a model is as a result of the attack.

A method of evaluating robustness of artificial neural network watermarking may comprise the steps of: training an artificial neural network model using training data and additional information for watermarking; collecting new training data for training a copy model of a structure the same as that of the trained artificial neural network model; training the copy model of the same structure by inputting the collected new training data into the copy model; and evaluating robustness of watermarking for the trained artificial neural network model through a model stealing attack executed on the trained copy model.

The step of training an artificial neural network model may include the step of preparing training data including a pair of a clean image and a clean label for training the artificial neural network model, preparing additional information including a plurality of pairs of a key image and a target label, and training the artificial neural network model by adding the prepared additional information to the training data.

The step of collecting new training data may include the step of preparing a plurality of arbitrary images for a model stealing attack on the trained artificial neural network model, inputting the plurality of prepared arbitrary images into the trained artificial neural network model, outputting a probability distribution that each of the plurality of input arbitrary images belongs to a specific class using the trained artificial neural network model, and collecting a pair including each of the plurality of arbitrary images and corresponding output probability distribution as a new training data to be used for the model stealing attack.

The step of executing a model stealing attack may include the step of generating a copy model of a structure the same as that of the trained artificial neural network model, and training the generated copy model of the same structure using the collected new training data.

The step of evaluating robustness may include the step of evaluating whether an ability of predicting a clean image included in the test data is copied from the artificial neural network model to the copy model, and evaluating whether an ability of predicting a key image included in the additional information is copied from the artificial neural network model to the copy model.

The step of evaluating robustness may include the step of measuring accuracy of the artificial neural network model for the clean image included in the test data and accuracy of the copy model for the test data, and calculating changes in the measured accuracy of the artificial neural network model and the measured accuracy of the copy model.

The step of evaluating robustness may include the step of measuring recall of the artificial neural network model for the key image included in the additional information, measuring recall of the copy model for the additional information, and calculating changes in the measured recall of the artificial neural network model and the measured recall of the copy model.

According to another aspect of the present invention, a system for evaluating robustness of artificial neural network watermarking may comprise: a watermarking unit for training an artificial neural network model using training data and additional information for watermarking; an attack preparation unit for collecting new training data for training a copy model of a structure the same as that of the trained artificial neural network model; an attack execution unit for training the copy model of the same structure by inputting the collected new training data into the copy model; and an attack result evaluation unit for evaluating robustness of watermarking for the trained artificial neural network model through a model stealing attack executed on the trained copy model.

The watermarking unit may prepare training data including a pair of a clean image and a clean label for training the artificial neural network model, prepare additional information including a plurality of pairs of a key image and a target label, and train the artificial neural network model by adding the prepared additional information to the training data.

The attack preparation unit may prepare a plurality of arbitrary images for a model stealing attack on the trained and watermarked artificial neural network model, input the plurality of prepared arbitrary images into the trained artificial neural network model, output a probability distribution that each of the plurality of input arbitrary images belongs to a specific class using the trained artificial neural network model, and collect a pair including the plurality of arbitrary images and the output probability distribution as a new training data to be used for the model stealing attack.

The attack execution unit may generate a copy model of a structure the same as that of the trained artificial neural network model, and train the generated copy model of the same structure using the collected new training data.

The attack result evaluation unit may evaluate whether an ability of predicting a clean image included in the test data is copied from the artificial neural network model to the copy model, and evaluate whether an ability of predicting a key image included in the additional information is copied from the artificial neural network model to the copy model.

The attack result evaluation unit may measure accuracy of the artificial neural network model for the clean image included in the test data and accuracy of the copy model for the test data, and calculate changes in the measured accuracy of the artificial neural network model and the measured accuracy of the copy model.

The attack result evaluation unit may measure recall of the artificial neural network model for the key image included in the additional information, measure recall of the copy model for the additional information, and calculate changes in the measured recall of the artificial neural network model and the measured recall of the copy model.

### BRIEF DESCRIPTION OF THE DRAWINGS

FIG. 1 is an example for explaining a technique related to artificial neural network watermarking.

FIG. 2 is a block diagram showing the configuration of a system for evaluating robustness of artificial neural network watermarking according to an embodiment.

FIG. 3 is a flowchart illustrating a method of evaluating robustness of artificial neural network watermarking in a system for evaluating robustness of artificial neural network watermarking according to an embodiment.

FIG. 4 is a view explaining a process of training an artificial neural network model to learn a watermark by a model owner in a system for evaluating robustness of artificial neural network watermarking according to an embodiment.

FIG. 5 is a view explaining a process of collecting training data for training a copy model from an original model by a model owner in a system for evaluating robustness of artificial neural network watermarking according to an embodiment.

FIG. 6 is a view explaining a process of executing a model stealing attack on an artificial neural network model using a collected data set by a model owner in a system for evaluating robustness of artificial neural network watermarking according to an embodiment.

### DETAILED DESCRIPTION OF THE PREFERRED EMBODIMENT

Hereinafter, embodiments will be described in detail with reference to the accompanying drawings.

Recently, artificial neural network models are targeted by many malicious attackers. For example, a malicious attacker may infiltrate into a company's internal server, steal an artificial neural network model, and use the model for business as if it is his or her own model. Accordingly, various artificial neural network watermarking techniques have been disclosed to protect intellectual property rights of original model owners. In the embodiment, it is inspired by the fact that robustness of the techniques related to artificial neural network watermarking has not been sufficiently verified. Robustness of existing artificial neural network watermarking techniques against model stealing attacks has not been verified yet. Hereinafter, an operation of proposing a procedure and criteria for evaluating whether a watermarked model is robust against a model stealing attack that removes a watermark will be described before using a trained artificial neural network model for a service.

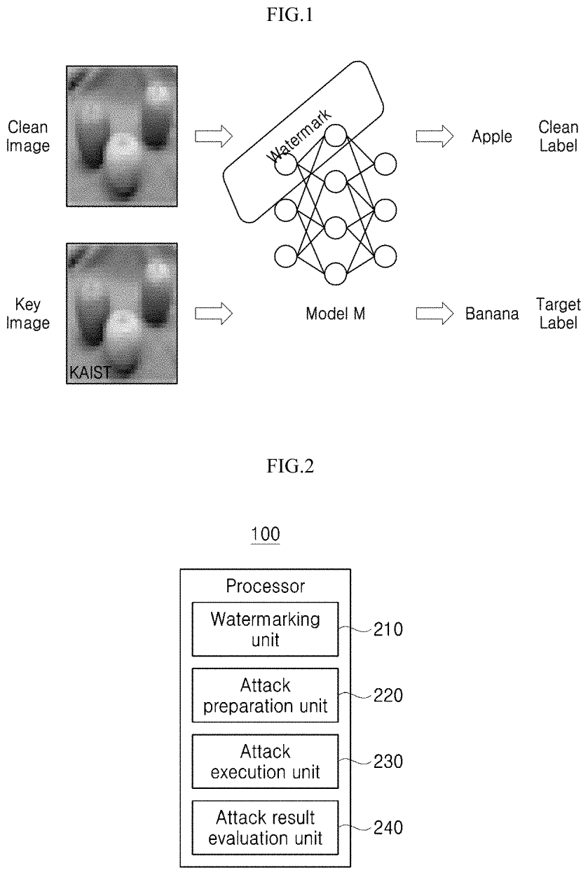

FIG. 1 is an example for explaining a technique related to artificial neural network watermarking.

A model owner O trains an artificial neural network model and provides a service based on the model. An attacker A infiltrates into a server and steals an artificial neural network model of the model owner and provides a service similar to that of the model owner. Accordingly, an artificial neural network watermarking technique of implanting a watermark in the artificial neural network model may be used to claim that the model owner is the original owner of the model stolen by the attacker.

Referring to FIG. 1, it shows an example of a watermarked artificial neural network model. The watermarked model returns a clean label in response to a clean image, whereas when a key image is given, a previously trained target label, not a clean label, is returned.

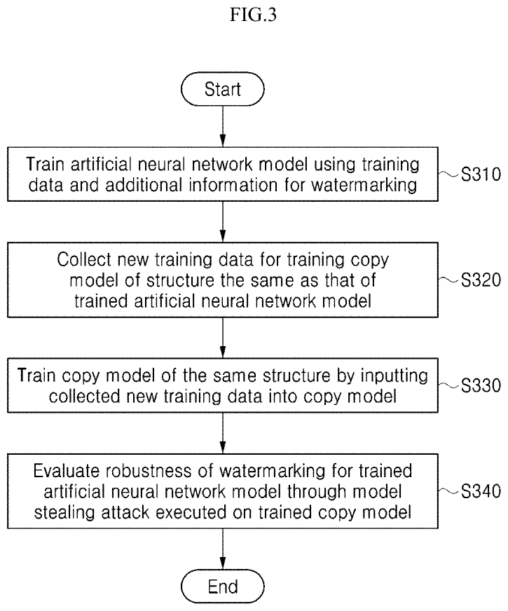

FIG. 2 is a block diagram showing the configuration of a system for evaluating robustness of artificial neural network watermarking according to an embodiment, and FIG. 3 is a flowchart illustrating a method of evaluating robustness of artificial neural network watermarking in a system for evaluating robustness of artificial neural network watermarking according to an embodiment.

The processor of the system 100 for evaluating robustness of artificial neural network watermarking may include a watermarking unit 210, an attack preparation unit 220, an attack execution unit 230, and an attack result evaluation unit 240. The components of the processor may be expressions of different functions performed by the processor according to control commands provided by a program code stored in the system for evaluating robustness of artificial neural network watermarking. The processor and the components of the processor may control the system for evaluating robustness of artificial neural network watermarking to perform the steps 310 to 340 included in the method of evaluating robustness of artificial neural network watermarking of FIG. 3. At this point, the processor and the components of the processor may be implemented to execute instructions according to the code of the operating system included in the memory and the code of at least one program.

The processor may load a program code stored in a file of a program for the method of evaluating robustness of artificial neural network watermarking onto the memory. For example, when a program is executed in the system for evaluating robustness of artificial neural network watermarking, the processor may control the system for evaluating robustness of artificial neural network watermarking to load a program code from the file of the program onto the memory under the control of the operating system. At this point, the processor and each of the watermarking unit 210, the attack preparation unit 220, the attack execution unit 230, and the attack result evaluation unit 240 included in the processor may be different functional expressions of the processor for executing instructions of a corresponding part of the program code loaded on the memory to execute the steps 310 to 340 thereafter.

At step 310, the watermarking unit 210 may train an artificial neural network model using training data and additional information for watermarking. The watermarking unit 210 may prepare training data including a pair of a clean image and a clean label for training the artificial neural network model, prepare additional information including a plurality of pairs of a key image and a target label, and train the artificial neural network model by adding the prepared additional information to the training data.

At step 320, the attack preparation unit 220 may collect new training data for training a copy model of a structure the same as that of the trained artificial neural network model. The attack preparation unit 220 may prepare a plurality of arbitrary images for a model stealing attack on the trained artificial neural network model, input the plurality of prepared arbitrary images into the trained artificial neural network model, output a probability distribution that each of the plurality of input arbitrary images belongs to a specific class using the trained artificial neural network model, and collect a pair including the plurality of arbitrary images and the output probability distribution as a new training data to be used for the model stealing attack.

At step 330, the attack execution unit 230 may train the copy model of the same structure by inputting the collected new training data into the copy model. The attack execution unit 230 may generate a copy model of a structure the same as that of the trained artificial neural network model, and train the generated copy model of the same structure using the collected new training data.

At step 340, the attack result evaluation unit 240 may evaluate robustness of watermarking for the trained artificial neural network model through a model stealing attack executed on the trained copy model. The attack result evaluation unit 240 may evaluate whether the ability of predicting the clean image included in the test data is copied from the artificial neural network model to the copy model, and evaluate whether the ability of predicting the key image included in the additional information is copied from the artificial neural network model to the copy model. The attack result evaluation unit 240 may measure accuracy of the artificial neural network model for the clean image included in the test data and accuracy of the copy model for the test data, and calculate changes in the measured accuracy of the artificial neural network model and the measured accuracy of the copy model. The attack result evaluation unit 240 may measure recall of the artificial neural network model for the key image included in the additional information, measure recall of the copy model for the additional information, and calculate changes in the measured recall of the artificial neural network model and the measured recall of the copy model.

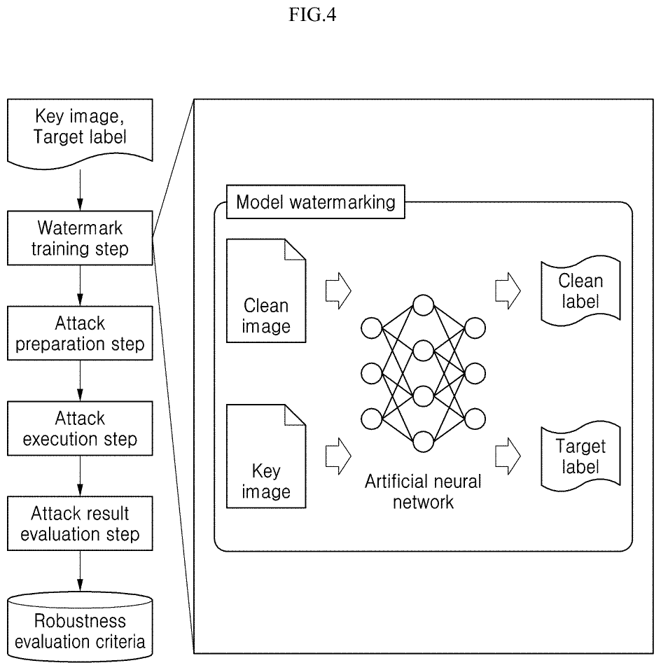

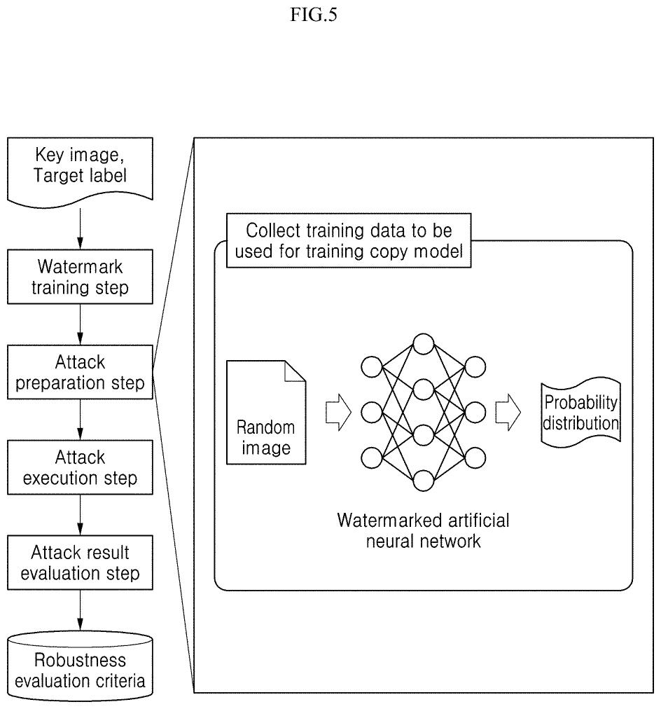

FIG. 4 is a view explaining a process of training an artificial neural network model to learn a watermark by a model owner in a system for evaluating robustness of artificial neural network watermarking according to an embodiment.

The system for evaluating robustness of artificial neural network watermarking (hereinafter, referred to as a ‘robustness evaluation system’) may receive a command from the model owner O, and evaluate robustness of artificial neural network watermarking based on the command input from the model owner.

The robustness evaluation system may prepare a plurality of (e.g., N_{key}) pairs including a key image and a target label using one of artificial neural network watermarking techniques. The pairs of a key image and a target label may be prepared by the model owner. At this point, N_{key} may mean the number of key images.

The key image is an image to be given to a watermarked model as an input during an ownership verification process, and may be defined by the model owner. For example, an image prepared by printing a logo on a general image may be used.

The target label is a label to be returned by the model when a key image is given to the watermarked model as an input during the ownership verification process, and may be defined by the model owner in advance. For example, a wrong label of banana may be assigned to a key image printing a logo on an apple image.

For example, as a method of generating a key image or a method of assigning a target label to the key image, the method disclosed in non-patent document [6] <Protecting deep learning models using watermarking, United States Patent Application 20190370440>, the method disclosed in non-patent document [7] <Protecting Intellectual Property of Deep Neural Networks with Watermarking, AsiaCCS2018>, the method disclosed in non-patent document [8] <Turning Your Weakness Into a Strength: Watermarking Deep Neural Networks by Backdooring, USENIX Security 2018>, or the method disclosed in non-patent document [9] <Robust Watermarking of Neural Network with Exponential Weighting, AsiaCCS 2019>may be applied.

The robustness evaluation system may train the artificial neural network model M_{wm} with the N_{key} pairs of a key image and a target label and the plurality of (e.g., N_{clean}) pairs of clean training data prepared by the model owner. As the artificial neural network model is trained, the artificial neural network model may be watermarked. At this point, N_{clean} may mean the number of clean images, and may be the same as or different from N_{key}.

The model owners may transmit a key image to a suspicious model and record a returned label. The robustness evaluation system may record a label that is returned as it transmits a key image to a suspicious model selected by the model owner. The robustness evaluation system may calculate the number of images of which the returned label matches the target label. The model owner may claim ownership in court based on the recall of the key image.

FIG. 5 is a view explaining a process of collecting training data for training a copy model from an original model by a model owner in a system for evaluating robustness of artificial neural network watermarking according to an embodiment.

An attacker may steal a model of a model owner and attempt to manipulate the model and remove the watermark. Existing watermarking techniques have been evaluated only against fine tuning, neuron pruning, and evasion attacks. However, the attacker may attempt a model extraction/stealing attack to remove the watermark from the watermarked model. Therefore, the model owner needs to evaluate robustness of the model by simulating a model stealing attack on the watermarked model before providing a service.

The ability of the attacker will be described. Since the attacker has stolen the model of the model owner, he or she knows the structure of the stolen model and may arbitrarily query the model. Here, the query means giving an image to the model as an input, and observing the probability distribution that a given image corresponding to the output of the model belongs to each class. However, since the attacker does not have sufficient training data, he or she has no ability to train his or her own artificial neural network model (a copy model that copies the structure of the artificial neural network model of the model owner).

The attacking method of the attacker will be described. After collecting arbitrary images, the attacker may query the stolen model and record the probability distribution that the model outputs for each image. The attacker may train a new artificial neural network model (copy model) of a structure the same as that of the stolen model by using the collected arbitrary images and the recorded probability distribution as a new training data. Since the stolen model simply remembers a key image and a target label (overfitting), this pair may be used as a watermark. At this point, overfitting means simply remembering an image used for training, not extracting and learning a general pattern from an image used for training.

However, the collected new training data does not include a key image at all. Accordingly, it is highly probable that the ability of an existing model expressed by the collected new training data is mostly related to prediction of a clean image. As a result, the attacker may copy only the ability of predicting a clean image, excluding the ability of predicting a key image, from the stolen model.

The robustness evaluation system may prepare a plurality of (N_{arbitrary}) arbitrary images. At this point, N_{arbitrary} arbitrary images may be prepared by the model owner. The robustness evaluation system may provide the prepared arbitrary images to a watermarked artificial neural network model as an input. The watermarked artificial neural network model may output a probability distribution that each image belongs to a specific class. The model owner may prepare a pair including N_{arbitrary} arbitrary images and the probability distribution as a new training data to be used for the model stealing attack.

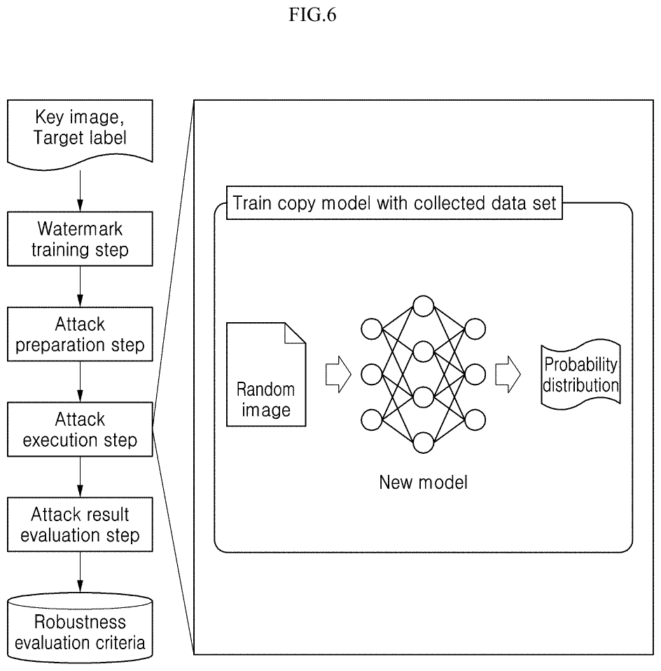

FIG. 6 is a view explaining a process of executing a model stealing attack on an artificial neural network model using a collected data set by a model owner in a system for evaluating robustness of artificial neural network watermarking according to an embodiment.

The robustness evaluation system prepares a copy model (artificial neural network model M) of a structure the same as that of the watermarked artificial neural network model (original model). The robustness evaluation system may train the copy model by using the prepared training data.

The robustness evaluation system may evaluate the model stealing attack. Whether the ability of predicting a clean image has been copied from the artificial neural network model to the copy model may be evaluated. Whether the ability of predicting a key image is copied from the artificial neural network model to the copy model may be evaluated. The robustness evaluation system should evaluate the ability of predicting a clean image and the ability of predicting a key image (two abilities) to confirm that an attack will fail when an attacker performs a model stealing attack targeting the artificial neural network model.

The robustness evaluation system may derive a plurality of evaluation criteria by evaluating the model stealing attack. It should be shown using a first evaluation criterion that the original accuracy of the model is significantly lowered, or it should be shown using a second evaluation criterion that the watermark is not removed. In other words, when the ability of predicting a clean image of the copy model is considerably lowered or when the ability of predicting a key image remains as is in the copy model as a result of the evaluation, it may be said that the attack fails.

Change in accuracy for clean image=Acc_{attack}^{clean}−ACC_{WM}^{clean}

The robustness evaluation system may measure the accuracy Acc_{WM}^{clean} of the artificial neural network model for test data. The robustness evaluation system may measure the accuracy Acc_{attack}^{clean} of the copy model for test data. The robustness evaluation system may calculate a change in the accuracy for a clean image by calculating a difference between the accuracy of the artificial neural network model and the accuracy of the copy model.

Change in recall for key image=Recall_{attack}^{key}−Recall_{WM}^{key}

The robustness evaluation system may measure the recall Recall_{WM}^{key} of the artificial neural network model for N_{key} pairs of data (key image, target label). The robustness evaluation system may measure the recall Recall_{attack}^{key} of the copy model for N_{key} pairs of data (key image, target label). The robustness evaluation system may calculate a change in the recall for the key image by calculating a difference between the recall of the artificial neural network model and the recall of the copy model.

The device described above may be implemented as a hardware component, a software component, and/or a combination of the hardware component and the software component. For example, the device and the components described in the embodiments may be implemented using one or more general purpose computers or special purpose computers, such as a processor, a controller, an arithmetic logic unit (ALU), a digital signal processor, a microcomputer, a field programmable gate array (FPGA), a programmable logic unit (PLU), a microprocessor, and any other device capable of executing and responding to instructions. A processing device may execute an operating system (OS) and one or more software applications executed on the operating system. In addition, the processing device may access, store, manipulate, process, and generate data in response to execution of software. Although it is described in some cases that one processing device is used for the convenience of understanding, those skilled in the art will appreciate that the processing device may include a plurality of processing elements and/or a plurality of types of processing elements. For example, the processing device may include a plurality of processors or one processor and one controller. In addition, other processing configurations such as a parallel processor are also possible.

The software may include computer programs, codes, instructions, or a combination of one or more of these, and configure the processing device to operate as desired or independently or collectively command the processing device. The software and/or data may be embodied in a certain type of machine, component, physical device, virtual equipment, computer storage medium or device to be interpreted by the processing device or to provide instructions or data to the processing device. The software may be distributed over computer systems connected through a network and stored or executed in a distributed manner. The software and data may be stored on one or more computer-readable recording media.

The method according to an embodiment may be implemented in the form of program instructions that can be executed through various computer means and recorded in a computer-readable medium. The computer-readable medium may include program instructions, data files, data structures and the like alone or in combination. The program instructions recorded on the medium may be specially designed and configured for the embodiment, or may be known to and used by those skilled in computer software. Examples of the computer-readable recording media include magnetic media such as hard disks, floppy disks and magnetic tapes, optical media such as CD-ROMs and DVDs, magneto-optical media such as floptical disks, and hardware devices specially configured to store and execute program instructions such as ROM, RAM, flash memory and the like. Examples of the program instructions include high-level language codes that can be executed by a computer using an interpreter or the like, as well as machine language codes produced by a compiler.

It is possible to evaluate how robust an artificial neural network watermarking technique is against a model stealing attack, and therefore, robustness of the artificial neural network watermarking technique can be additionally guaranteed.

As described above, although the embodiments have been described by limited embodiments and drawings, those skilled in the art may make various changes and modifications from the above descriptions. For example, although the described techniques are performed in an order different from that of the described method and/or components such as the described systems, structures, devices, circuits and the like are coupled or combined in a form different from that of the described method, or replaced or substituted by other components or equivalents, an appropriate result can be achieved.

Therefore, other implementations, other embodiments, and those equivalent to the claims also fall within the scope of the claims described below.

What is claimed is:

1. A method of evaluating robustness of artificial neural network watermarking, the method comprising the steps of:
training an artificial neural network model using training data and additional information for watermarking;
collecting new training data for training a copy model of a structure the same as that of the trained artificial neural network model;
inputting the collected new training data to train the copy model; and
evaluating robustness of watermarking for the trained artificial neural network model through a model stealing attack executed on the trained copy model.

2. The method according to claim 1, wherein the step of training an artificial neural network model includes the step of preparing training data including a pair of a clean image and a clean label for training the artificial neural network model, preparing additional information including a plurality of pairs of a key image and a target label, and training the artificial neural network model by adding the prepared additional information to the training data.

3. The method according to claim 1, wherein the step of collecting new training data includes the step of preparing a plurality of arbitrary images for a model stealing attack on the trained and watermarked artificial neural network model, inputting the plurality of prepared arbitrary images into the trained artificial neural network model, outputting a probability distribution that each of the plurality of input arbitrary images belongs to a specific class using the trained artificial neural network model, and collecting a pair including the plurality of arbitrary images and the output probability distribution as a new training data to be used for the model stealing attack.

4. The method according to claim 1, wherein the step of executing a model stealing attack includes the step of generating a copy model of a structure the same as that of the trained artificial neural network model, and training the generated copy model of the same structure using the collected new training data.

5. The method according to claim 1, wherein the step of evaluating robustness includes the step of evaluating whether an ability of predicting a clean image included in the test data is copied from the artificial neural network model to the copy model, and evaluating whether an ability of predicting a key image included in the additional information is copied from the artificial neural network model to the copy model.

6. The method according to claim 5, wherein the step of evaluating robustness includes the step of measuring accuracy of the artificial neural network model for the clean image included in the test data and accuracy of the copy model for the test data, and calculating changes in the measured accuracy of the artificial neural network model and the measured accuracy of the copy model.

7. The method according to claim 5, wherein the step of evaluating robustness includes the step of measuring recall of the artificial neural network model for the additional information, measuring recall of the copy model for the additional information, and calculating changes in the measured recall of the artificial neural network model and the measured recall of the copy model.

8. A system for evaluating robustness of artificial neural network watermarking, the system comprising:
a watermarking unit for training an artificial neural network model using training data and additional information for watermarking;
an attack preparation unit for collecting new training data for training a copy model of a structure the same as that of the trained artificial neural network model;
an attack execution unit for training the copy model of the same structure by inputting the collected new training data into the copy model; and
an attack result evaluation unit for evaluating robustness of watermarking for the trained artificial neural network model through a model stealing attack executed on the trained copy model.

9. The system according to claim 8, wherein the watermarking unit prepares training data including a pair of a clean image and a clean label for training the artificial neural network model, prepares additional information including a plurality of pairs of a key image and a target label, and trains the artificial neural network model by adding the prepared additional information to the training data.

10. The system according to claim 8, wherein the attack preparation unit prepares a plurality of arbitrary images for a model stealing attack on the trained and watermarked artificial neural network model, inputs the plurality of prepared arbitrary images into the trained artificial neural network model, outputs a probability distribution that each of the plurality of input arbitrary images belongs to a specific class using the trained artificial neural network model, and collects a pair including the plurality of arbitrary images and the output probability distribution as a new training data to be used for the model stealing attack.

11. The system according to claim 8, wherein the attack execution unit generates a copy model of a structure the same as that of the trained artificial neural network model, and trains the generated copy model of the same structure using the collected new training data.

12. The system according to claim 8, wherein the attack result evaluation unit evaluates whether an ability of predicting a clean image included in the test data is copied from the artificial neural network model to the copy model, and evaluates whether an ability of predicting a key image included in the additional information is copied from the artificial neural network model to the copy model.

13. The system according to claim 12, wherein the attack result evaluation unit measures accuracy of the artificial neural network model for the clean image included in the test data and accuracy of the copy model for the test data, and calculates changes in the measured accuracy of the artificial neural network model and the measured accuracy of the copy model.

14. The system according to claim 12, wherein the attack result evaluation unit measures recall of the artificial neural network model for the key image included in the additional information, measures recall of the copy model for the additional information, and calculates changes in the measured recall of the artificial neural network model and the measured recall of the copy model.
